(19) United States
(12) Patent Application Publication
(10) Pub. No.: US 2022/0180289 A1
(43) Pub. Date: Jun. 9, 2022

(54) COGNITIVE USER SELECTION

(71) Applicant: International Business Machines Corporation, Armonk, NY (US)

(72) Inventors: Marco Luca Sbodio, Dublin (IE); Joao H Bettencourt-Silva, Dublin (IE); Natalia Mulligan, Dublin (IE); Gabriele Picco, Dublin (IE)

(21) Appl. No.: 17/116,751

(22) Filed: Dec. 9, 2020

(51) Int. Cl. G06Q 10/06; G06N 5/04; G06N 20/00

(52) U.S. Cl. CPC G06Q 10/063112; G06N 20/00; G06N 5/045; G06Q 10/06398

(57) ABSTRACT

A processor may identify a task to be performed by a group of users. The processor may determine one or more requirements for performance of the task. The processor may determine, from one or more categories of users, potential users for the group of users. The processor may analyze one or more metrics of the potential users, where the one or more metrics of the potential users includes a first physical metric. The processor may generate, utilizing an AI model, one or more suggested groups of suggested users based on the one or more metrics of the potential users.

### BACKGROUND

The present disclosure relates generally to the field of cognitive selection of groups of users, and more specifically to selection of groups based on one or more metrics of potential users.

Many factors can affect the effectiveness of a group of users at performing a task. These factors are critical when the task is a highly impactful task that has a critical outcome. Artificial intelligence models may help in the selection of these groups of users.

### SUMMARY

Embodiments of the present disclosure include a method, computer program product, and system for selecting of groups based on one or more metrics of potential users.

A processor may identify a task to be performed by a group of users. The processor may determine one or more requirements for performance of the task. The processor may determine, from one or more categories of users, potential users for the group of users. The processor may analyze one or more metrics of the potential users, where the one or more metrics of the potential users includes a first physical metric. The processor may generate, utilizing an AI model, one or more suggested groups of suggested users based on the one or more metrics of the potential users.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A is a block diagram of an exemplary system for cognitive selection of groups of users, in accordance with aspects of the present disclosure.

FIG. 1B is a block diagram of components of an exemplary system for cognitive selection of groups of users, in accordance with aspects of the present disclosure.

FIG. 2 is a flowchart of an exemplary method for cognitive selection of groups of users, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of cognitive selection of groups of users, and more specifically to selection of groups based on one or more metrics of potential users. While the present disclosure is not necessarily limited to such applications, various aspects of the disclosure may be appreciated through a discussion of various examples using this context.

In some embodiments, a processor may identify a task to be performed by a group of users. In some embodiments, the processor may determine one or more requirements for performance of the task. In some embodiments, the task may be a high impact task that requires the group of users to perform critical decision making. In some embodiments, the task may be input by an individual into a computer, AI model, or team selection application. In some embodiments, the requirements for performance of the task may be conditions for completion of the task, including skills required by users, deadlines for the task, expected start time, expected end time, etc. In some embodiments, the requirements for performance of the task may be input by an individual. In some embodiments, the requirements may be obtained from a database compiling tasks and requirements for the performance of the task.

In some embodiments, the processor may determine, from one or more categories of users, potential users for the group of users. In some embodiments, the processor may determine one or more categories of users. In some embodiments, the group of users may have members, and the members may be categorized into group member types. In some embodiments, the categories may include classifications based on the role a member plays in the group, based on the skill level of the members, based on specific skills of the members, etc. For example, the role may be based on a differentiation of subtasks performed for the larger task to be completed. In some embodiments, the one or more categories may be input by an individual. In some embodiments, the one or more categories may be obtained from a database compiling tasks and one or more categories of users.

For example, the task could be to perform a surgery, and members of the group that is to perform the surgery may be broken down into categories of members based on job titles (e.g., two interns, one resident surgeon, one surgery attending, and three surgery nurses). In some embodiments, it is possible that different combinations of categories of group members may be used to form the group. For example, one group may have three entry level surgeons and two highly experienced surgeons while another group may have one highly skilled surgeon, one midlevel surgeon, and three entry level surgeons. In some embodiments, the processor may identify potential users for the group of users. Continuing the previous example, in a particular hospital, there may be a roster of highly skilled surgeons, midlevel skilled surgeons, entry level surgeons, interns, resident surgeons, surgery attending, surgery nurses, etc. to select from.

In some embodiments, the processor may analyze one or more metrics of the potential users. In some embodiments, the one or more metrics of the potential users may include a first physical metric. In some embodiments, the one or more metrics of the potential users may be relevant to the performance of the task. For example, the one or more metrics may relate to an expertise level of a potential user, the availably of the potential user, specials skills of the potential user. In some embodiments, the first physical metric may relate to physiological characteristics of a person that affect their alertness and mental acuity. In some embodiments, the first physical metric may relate to the circadian rhythms of a potential user. In some embodiments, the first physical metric may relate to coordination ability, information processing abilities, executive functions, critical thinking, problem solving, analytical skills, creativity, etc. For example, the circadian rhythms of groups of people who work in shifts or travel a lot may be factored into the ability of the group to perform a task.

In some embodiments, the processor may generate, utilizing an AI model, one or more suggested groups of suggested users based on the one or more metrics of the potential users. For example, the output from the AI model may be a first suggested group having a particular head surgeon, three entry level surgeons, and three nurses. The AI model may also generate a second suggested group having a different head surgeon, a particular midlevel surgeon, two entry level surgeons, and three nurses. In some embodiments, the AI model may utilize a scheduling model. In some embodiments, the AI model may utilize fuzzy optimization models for team selection. In some embodiments, the AI model may output a timing for performance of the task. For example, a deadline for performance of the task may be provided, a start time, multiple possible start times, a time range within which to begin performance of the task, etc.

In some embodiments, the processor may evaluate the one or more suggested groups based on the first physical metrics of the suggested users. In some embodiments, the processor may provide a first physical metric evaluation to a controller. In some embodiments, the evaluation may be based on the circadian rhythms of the suggested users in the suggested group. In some embodiments, the evaluation may predict the effect of the first physical metric of a member (e.g., suggested user) of the suggested group on the performance of the task. In some embodiments, the first physical metric evaluation may be provided as a numerical value that quantifies the predicted, potential effect on the group's performance that is associated with the circadian rhythms of the suggested users in the suggested group. For example, if a group includes multiple suggested users who are scheduled to perform a task when they are sleep deprived, the risk evaluation may be 0.7 (on a scale of 0 to 1), indicating a high risk, whereas if a group includes suggested users who are scheduled to perform the task when they are well rested, the risk evaluation may be 0.2, indicating a low risk.

In some embodiments, the risk evaluation may be provided for each of the one or more suggested groups (e.g., an evaluation for a first group of suggested users & an evaluation for a second group of suggested users). In some embodiments, the evaluation may be provided to a controller of a computer system that selects a group to perform the task from the suggested groups. For example, the controller may be programmed to select the suggested group with the evaluation indicating the lowest risk to performance of the task based on the first physical metric. As another example, the controller may provide the risk evaluation to a user, and the user may determine which suggested group to select.

In some embodiments, the processor may generate an explanation for each of the one or more suggested groups. In some embodiments, the processor may provide the explanation to the controller. In some embodiments, the explanation may clarify the reasons for to the generation of the suggested groups made of suggested users. In some embodiments, the processor may generate an explanation for the first physical metric evaluation. In some embodiments, the explanation may clarify reasons for giving the first physical metric evaluation, as it relates to one or more individuals, potential users not put in the group, a comparison of one potential user's first physical metric to another potential user's physical metric, a comparison the one or more metrics of one potential user compared to the one or more metrics of another potential user, the requirements for performance of the task, historical data regarding past performance of tasks by potential users, etc.

In some embodiments, the explanation may relate to specific information about past outcomes related to performance of the task (e.g., amount of errors made) and past first physical metrics of suggested users in the suggested group. For example, the explanation for the evaluation for the suggested group may specify that the evaluation was given because a particular surgeon may be predicted to have peak performance, considering her circadian rhythms, during the afternoon when the task is scheduled to be performed. As another example, the explanation may specify that a particular surgeon may not be predicted to have peak performance based at least in part on a first physical metric because she was on night duty the night before her scheduled surgery.

In some embodiments, the processor may receive feedback regarding the one or more suggested groups of potential users, the first physical metric evaluation, and the explanation. In some embodiments, the processor may provide the feedback to the AI model. In some embodiments, the feedback may be received from a user and/or the controller. For example, when offered multiple groups to perform a task, the user (e.g., group member, coordinator or administrator) may select the first suggested group rather than the second suggested group because the user may place greater emphasis on the skill level of the individuals in a particular category of users (e.g., head surgeon) than on the alertness level attributed to the individual in that category (e.g., the first group had a head surgeon that was more highly skilled but lower assessed alertness level than the head surgeon on the second suggested group).

In some embodiments, a user may provide feedback regarding the time in which the task was performed. For example, when offered a range of times in which to complete the task, a particular time may be selected because that time was the optimal time, based on the group members (e.g., suggested users) own productivity assessment, to perform the task. In some embodiments, feedback may be provided regarding the first physical metric evaluation. For example, feedback may be provided that it was not as accurate based on a user's subjective assessment. In some embodiments, feedback may be provided regarding the group's performance (e.g., the group performed better than expected or that group members were more alert). In some embodiments, feedback may be provided regarding the explanation provided (e.g., it was not high quality, not clear, or not focused on reasons that users found as helpful as other reasons). In some embodiments, the user feedback is obtained using a graphical user interface on a user device.

In some embodiments, the first physical metric evaluation may be generated by an artificial intelligence algorithm trained using historical first physical metric data and historical group performance data. In some embodiments, the historical first physical metric data may include data about the first physical metric of historical users. In some embodiments, the historical group performance data may include circadian rhythm attributes of potential group members, skills of potential group members, expertise levels of potential group members, work schedules (e.g., past and future events) of potential group members, events affecting the first physical metric of potential group members (e.g., recent long haul flights, night shifts, etc.), performance evaluation for past executed tasks, duration of the task (e.g., surgery took 3 hours), outcome of the task (e.g., surgery was successful, number of errors made while performing the task, etc.), date and time of the task, alertness levels of group members before and after performance of the task, etc.

In some embodiments, the first metric evaluation may be determined as a weighted aggregate of the productivity level of each suggested user in the suggested group. In some embodiments, taking into account the circadian rhythms of an individual, the productivity level (e.g., factoring in an individual's ability to be alert, coordinate with others, process information, back up other team members, etc.) of the individual may be quantified and expressed as a function over time (e.g., time duration expected for performance of the task). In some embodiments, the productivity levels of the individuals selected (e.g., suggested users) for the suggested group may be summed. In some embodiments, the individual productivity levels may be aggregated as a weighted sum, with different weights reflecting the criticality of the individual's performance to the group's performance (e.g., based on the expertise, leadership role, special skills, subtask, etc. of the individuals). In some embodiments, the weights are predefined. In some embodiments, the weights are determined using an algorithm that determines the weights for the productivity levels of the individuals based on an analysis of the criticality of the individual's performance.

In some embodiments, the explanation may be determined using a machine learning explanation technique. In some embodiments, artificial intelligence explanation models, such as local interpretable model-agnostic explanations, may be utilized to generate the explanation. In some embodiments, the explanation model may present a textual or visual artifact that provides a qualitative understanding of the relationship between a model's prediction (e.g., the model suggesting groups or the model determining the first physical metric evaluation) and the textual or visual artifact. In some embodiments, the model may explain the prediction of another artificial intelligence model (e.g., the model suggesting groups or the model determining the first physical metric evaluation) by presenting representative individual prediction and their explanations in a non-redundant way, framing the task as a submodular optimization problem. In some embodiments, the explanation may be interpretable, (e.g., by providing a qualitative understanding between the input variables and the response/output).

In some embodiments, the explanation may be determined based the predicted/estimated productivity levels of each suggested user in the suggested group (including information about the coordination ability, alertness, information processing abilities, ability backing up other team members, etc. of the users). For example, the suggested group may have three members/users, and for the task that is to be performed, the first member/user may have the most crucial function/subtask. The explanation provided about the selection of the group or the physical metric evaluation for the group may be a correlated of the first physical metric of the first member/user with the group's overall predicted performance (e.g., assessed by the first physical metric evaluation).

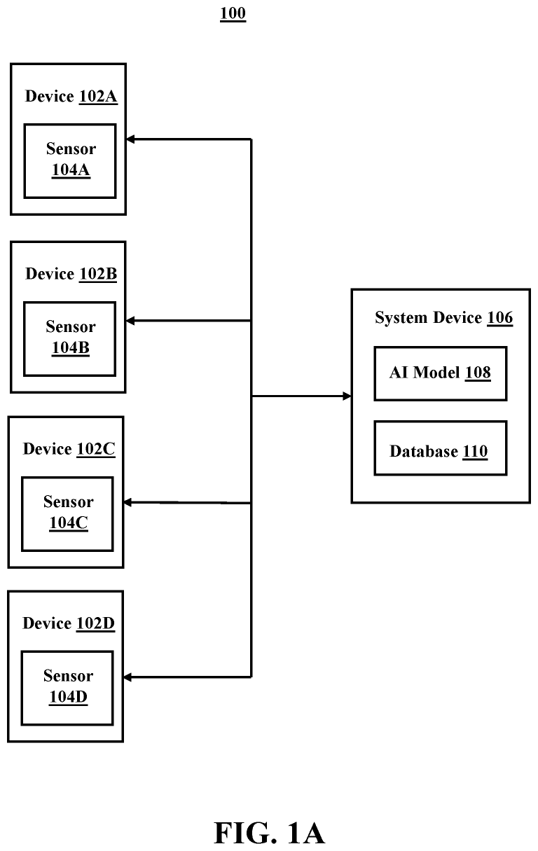

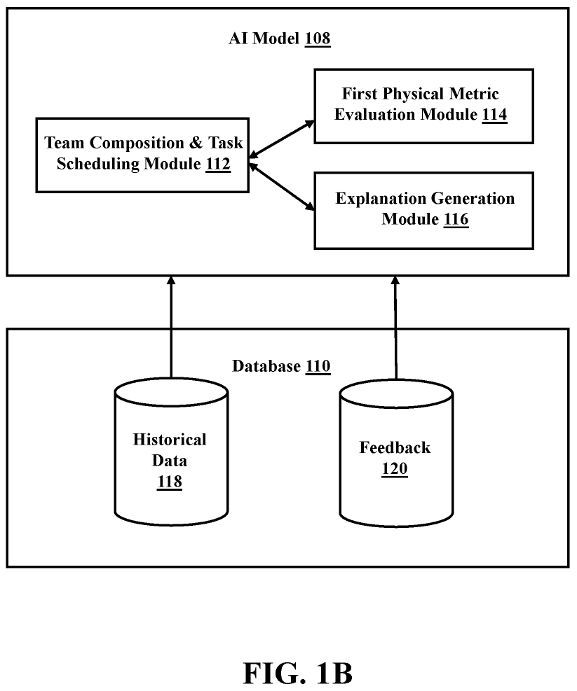

Referring now to FIG. 1A, a block diagram of a system 100 for cognitive group selection is illustrated. System 100 includes a devices 102A, 102B, 102C, and 102D and system device 106. The system device 106 includes an AI model 108 and database 110. The devices 102A, 102B, 102C, and 102D and system device 106 are configured to be in communication with each other. The devices 102A, 102B, 102C, and 102D and system device 106 may be any devices that contain a processor configured to perform one or more of the functions or steps described in this disclosure. The devices 102A, 102B, 102C, and 102D may be wearable devices (e.g., smartwatch, fitness tracker) having sensors 104A, 104B, 104C, and 104D to monitor features related to the circadian rhythms of the potential users.

In some embodiments, system device 106 identifies a task to be performed by a group of users. The system device 106 determines one or more requirements for performance of the task. The system device 106 determines, from one or more categories of users, potential users for the group of users. In some embodiments, the system device 106 determines one or more requirements for performance of the task or determines potential users for the group using data stored in database 110 identifying requirements for performance of the tasks or listing potential users for performing the task. The system device 106 analyzing one or more metrics of the potential users, where the one or more metrics of the potential users include a first physical metric. In some embodiments, the first physical metrics of potential users are determined using sensors 104A, 104B, 104C, and 104D on devices 102A, 102B, 102C, and 102D to monitor the circadian rhythms (and/or other metrics that can be sensed/measured, e.g., body temperature, eye focus, attentiveness, etc.) of the potential users. The system device 106 generates, utilizing the AI model 108, one or more suggested groups of suggested users based on the one or more metrics of the potential users. The system device also provides a time for the performance of the task (e.g., a set start time, a range of possible times, or a set deadline).

In some embodiments, the system device 106 evaluates the one or more suggested groups based on the first physical metrics of the suggested users and provides a first physical metric evaluation to a controller (not illustrated). In some embodiments, the system device 106 generates an explanation for the selection of the one or more suggested groups or the first physical metric evaluation and provides the explanation to the controller. In some embodiments, the system device 106 receives feedback regarding the one or more suggested groups of suggested users, the first physical metric evaluation, and the explanation and provides the feedback to the AI model 108.

Referring now to FIG. 1B, a block diagram of the AI model 108 and the database 110 utilized by the system device 106 (shown in FIG. 1A) is illustrated. The AI model 108 includes a team composition and task scheduling module 112 that is used to generate one or more suggested groups of suggested users based on one or more metrics of the potential users. The AI model 108 also includes a first physical metric evaluation module 114 that is used to evaluate the one or more suggested groups based on the first physical metric of the suggested users. An explanation generation module 116 of the AI model 108 is used to generate an explanation for each of the one or more suggested groups. The team composition and task scheduling module 112, the first physical metric evaluation module 114, and the explanation generation module 116 are configured to be in communication with each other. The AI model 108 receives data from database 110 including historical data 118 to train AI model 108 and each of the modules 112, 114, and 116. Feedback 120 regarding the one or more suggested groups of suggested users, the first physical metric evaluation, or the explanation is provided to the AI model 108.

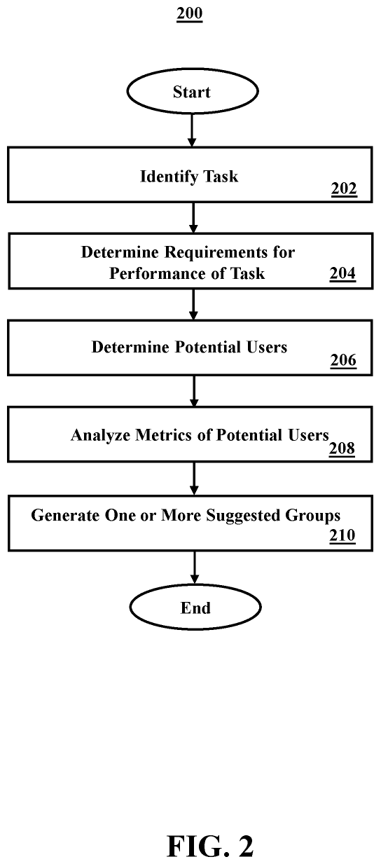

Referring now to FIG. 2, illustrated is a flowchart of an exemplary method 200 for cognitive group selection, in accordance with embodiments of the present disclosure. In some embodiments, a processor of a system may perform the operations of the method 200. In some embodiments, method 200 begins at operation 202. At operation 202, the processor identifies a task to be performed by a group of users. In some embodiments, method 200 proceeds to operation 204, where the processor determines one or more requirements for performance of the task. In some embodiments, method 200 proceeds to operation 206. At operation 206, the processor determines, from one or more categories of users, potential users for the group of users. In some embodiments, method 200 proceeds to operation 208. At operation 208, the processor analyzes one or more metrics of the potential users. The one or more metrics of the potential users includes a first physical metric. In some embodiments, method 200 proceeds to operation 210. At operation 210, the processor generates, utilizing an AI model, one or more suggested groups of suggested users based on the one or more metrics of the potential users.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

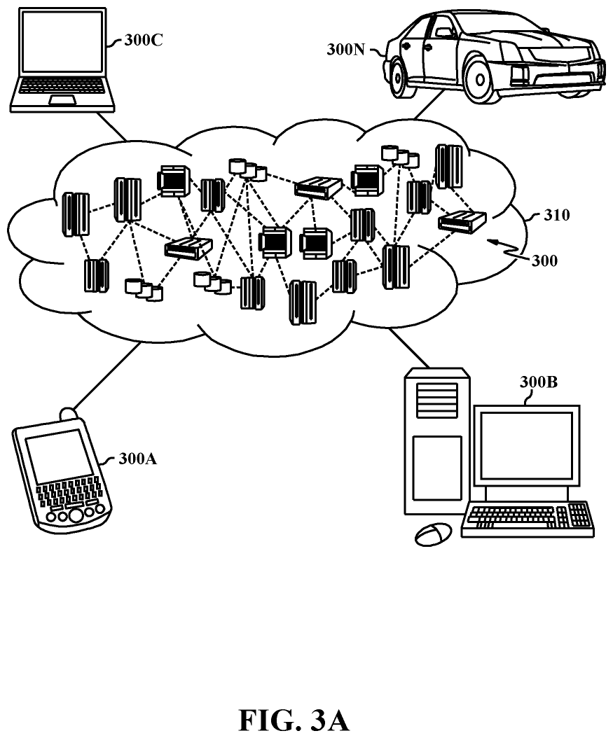

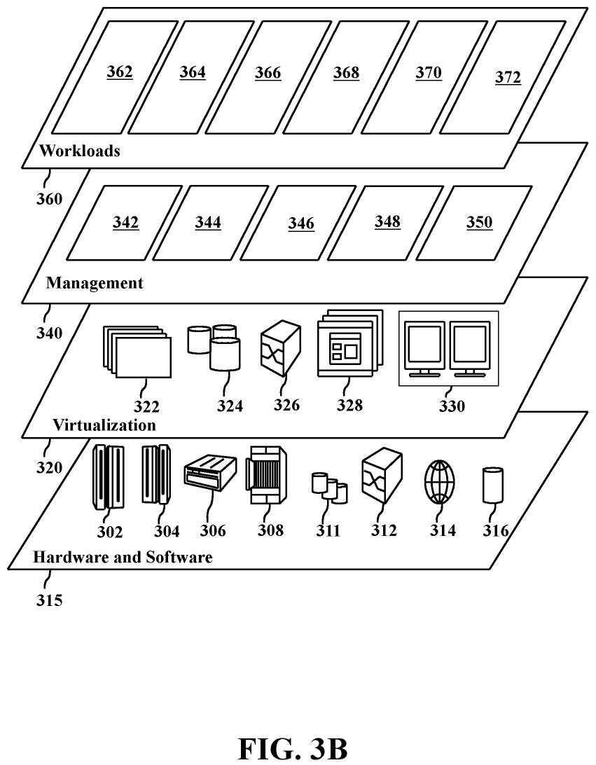

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and cognitive selection of groups of users 372.

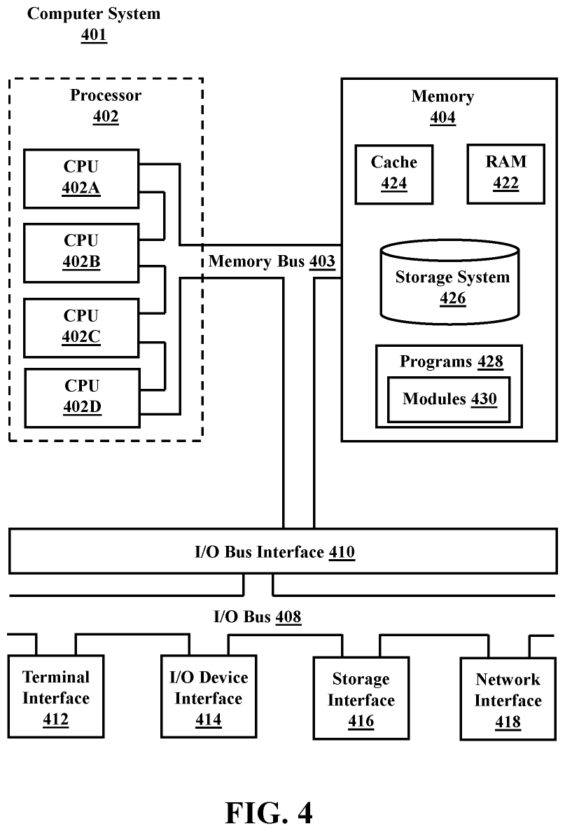

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

1. A computer-implemented method, the method comprising:
identifying, using a processor, a task to be performed by a group of users;
determining one or more requirements for performance of the task;
determining, from one or more categories of users, potential users for the group of users;
analyzing one or more metrics of the potential users, wherein the one or more metrics of the potential users include a first physical metric; and
generating, utilizing an artificial intelligence model, one or more suggested groups of suggested users based on the one or more metrics of the potential users.

2. The method of claim 1, further comprising:
evaluating the one or more suggested groups based on the first physical metrics of the suggested users; and
providing a first physical metric evaluation to a controller.

3. The method of claim 2, further comprising:
generating an explanation for each of the one or more suggested groups; and
providing the explanation to the controller.

4. The method of claim 3, further comprising:
receiving feedback regarding the one or more suggested groups of suggested users, the first physical metric evaluation, and the explanation; and
providing the feedback to the artificial intelligence model.

5. The method of claim 2, wherein the first metric evaluation is generated by an artificial intelligence algorithm trained using historical first physical metric data and historical group performance data.

6. The method of claim 2, wherein the first metric evaluation is determined as a weighted aggregate of the productivity level of each suggested user in the suggested group.

7. The method of claim of claim 3, wherein the explanation is determined using a machine learning explanation technique.

8. A system comprising:
a memory; and
a processor in communication with the memory, the processor being configured to perform operations comprising:
identifying a task to be performed by a group of users;
determining one or more requirements for performance of the task;
determining, from one or more categories of users, potential users for the group of users;
analyzing one or more metrics of the potential users, wherein the one or more metrics of the potential users include a first physical metric; and
generating, utilizing an artificial intelligence model, one or more suggested groups of suggested users based on the one or more metrics of the potential users.

9. The system of claim 8, the processor being further configured to perform operations including:
evaluating the one or more suggested groups based on the first physical metrics of the suggested users; and
providing a first physical metric evaluation to a controller.

10. The system of claim 9, the processor being further configured to perform operations including:
generating an explanation for each of the one or more suggested groups; and
providing the explanation to the controller.

11. The system of claim 10, the processor being further configured to perform operations including:
receiving feedback regarding the one or more suggested groups of suggested users, the first physical metric evaluation, and the explanation; and
providing the feedback to the artificial intelligence model.

12. The system of claim 9, wherein the first metric evaluation is generated by an artificial intelligence algorithm trained using historical first physical metric data and historical group performance data.

13. The system of claim 9, wherein the first metric evaluation is determined as a weighted aggregate of the productivity level of each suggested user in the suggested group.

14. The system of claim 10, wherein the explanation is determined using a machine learning explanation technique.

15. A computer program product comprising a computer readable storage medium having program instructions embodied therewith, the program instructions executable by a processor to cause the processor to perform operations, the operations comprising:
identifying a task to be performed by a group of users;
determining one or more requirements for performance of the task;
determining, from one or more categories of users, potential users for the group of users;
analyzing one or more metrics of the potential users, wherein the one or more metrics of the potential users include a first physical metric; and
generating, utilizing an artificial intelligence model, one or more suggested groups of suggested users based on the one or more metrics of the potential users.

16. The computer program product of claim 15, the processor being further configured to perform operations including:
evaluating the one or more suggested groups based on the first physical metrics of the suggested users; and
providing a first physical metric evaluation to a controller.

17. The computer program product of claim 16, the processor being further configured to perform operations including:
generating an explanation for each of the one or more suggested groups; and
providing the explanation to the controller.

18. The computer program product of claim 17, the processor being further configured to perform operations including:
receiving feedback regarding the one or more suggested groups of suggested users, the first physical metric evaluation, and the explanation; and
providing the feedback to the artificial intelligence model.

19. The computer program product of claim 16, wherein the first metric evaluation is generated by an artificial intelligence algorithm trained using historical first physical metric data and historical group performance data.

20. The computer program product of claim 16, wherein the first metric evaluation is determined as a weighted aggregate of the productivity level of each suggested user in the suggested group.
